(19) United States
(12) Patent Application Publication
(10) Pub. No.: US 2014/0048176 A1
(43) Pub. Date: Feb. 20, 2014

(54) Method of Joining Component Workpieces and Structure Made Thereby

(71) Applicant: Kenneth J. SUSNJARA, Birdseye, IN (US)

(72) Inventor: Kenneth J. SUSNJARA, Birdseye, IN (US)

(21) Appl. No.: 13/587,089

(22) Filed: Aug. 16, 2012

(51) Int. Cl. B27D 1/04; A47B 43/00

(52) U.S. Cl. 144/344; 312/257.1

(57) ABSTRACT

A method of adjoining a pair of workpieces together comprising forming a mortise on one of such workpieces and a tenon in the other workpiece wherein one of the mortise and tenon is provided with diverging surfaces along the length thereof, inserting the tenon into the mortise and displacing one of such workpieces relative to the other of the workpieces along a line of travel parallel to the length to the mortise to cause the diverging surfaces of one of the mortise and tenon to engage the surfaces of the other of the mortise and tenon thereby positioning the workpieces relative to each other.

This invention relates to a method of joining component workpieces together and to a structure made thereby.

### BACKGROUND OF THE INVENTION

A number of products such as furniture or cabinets are constructed from wood based sheet material such as plywood or particle board. To create a final product, parts made from such material must be attached together, such attachments typically consisting of two perpendicularly disposed panels attached at the point where they meet. Techniques used to join such panels together typically fall into two categories, those that are assembled at the point of manufacture and transported to the final destination fully assembled and those that are assembled at the final destination. It is desirable to transport unassembled parts to the final destination and assemble such parts at the installation site in that the individual unassembled parts are easier and less costly to transport than fully assembled products such as commercial and household furniture pieces.

To produce component parts at one site, ship such components to a second site and assemble such components into a final product at the second site requires assembly methods more suitable to an installation site than a part production site. It is desirable that the forms of the joints for securing such components together be low in cost, easy to manufacture, strong and secure, easy to assemble, require minimum or no tools, clamps or other fixtures, and be assembled without the requirement of waiting for glue, adhesives or bonding agents to dry or cure before the assembled product can be installed.

Existing methods for joining panels in such applications have certain shortcomings or limitations that make them less than fully desirable. Mechanical fasteners that attach to each panel and then connect to each other can be slow and time consuming in assembly, can be costly, may require extensive machining to accommodate them, generally require some type of tool or assembly, may not offer optimum joint strength and may be visible in the final assembled product, reducing the overall quality appearance of the product Systems that machine panel edges with undercuts so that the two panels slide and lock together also exist but such systems require multiple tools and special undercut tools and a more complex and costly machining process. Since a sufficient clearance must be maintained between panels to allow them to be easily slid together, joints tend to be loose and imprecise. Such joints also typically require some type of mechanical fastener or locking method to hold the parts in position while a glue or bonding agent dries or cures entailing additional components and tools and higher cost.

The principal objective of the present invention is to provide an improved method of joining components together to form a particular product which requires no additional hardware, fixtures or components, is easy to machine during the manufacture of the components, can be manually assembled without the need of tools, and is permanently bonded and can be installed and used when first assembled even before the glue or bonding agent has fully dried or cured. Additional objectives and benefits of the invention will be apparent from the following description of the preferred embodiment of the invention.

### SUMMARY OF THE INVENTION

The principal objective of the present invention is achieved by providing a method of joining first and second workpieces together generally comprising forming a mortise in the first workpiece and a tenon in the second workpiece wherein one of the mortise and tenon is provided with diverging surfaces along a length thereof, inserting the tenon into the mortise and displacing one of the workpieces relative to the other of the workpieces along a length of the mortise to cause the diverging surfaces of the one of the mortise and tenon to engage surfaces of other of the mortise and tenon thereby positioning the one workpiece relative to the other workpiece. Preferably, the engaging surfaces of the mortise and tenon are formed roughened or non-smooth to more firmly engage, the engaging surfaces of the tenon and mortise are wedgingly fitted together, the engaging surfaces are adhesively secured together and the engaging surfaces of both the mortise and the tenon converge. The invention further contemplates assemblies and structures such as commercial and household products formed by the use of such method,

### BRIEF DESCRIPTION OF THE DRAWINGS

FIG. 1 is a perspective view of portions of a pair of panels provided with a mortise and tenon intended to be joined together to secure such panels in a method embodying the present invention;

FIG. 2 is an enlarged, planar view of one of the panels shown in FIG. 1 provided with a mortise illustrating the position of the tenon of the other panel shown in FIG. 1, inserted in a first position in the mortise;

FIG. 3 is a view similar to the view shown in FIG. 2, illustrating the position of the tenon shown in FIG. 2 in a second position, securing such panels together;

FIG. 4 is a perspective view illustrating the manner in which one of the panels shown in FIG. 1 initially is inserted in the mortise of the other panel to position the tenon of one the panels in the mortise of the other panel as shown in FIG. 2;

FIG. 5 is a perspective view similar to the view shown in FIG. 4, illustrating the manner in which one of the panels is displaced relative to the other panel to position the tenon of one of the panels in the mortise of the other panel as shown in FIG. 3,

FIG. 6 is a perspective view of the panels shown in FIGS. 4 and 5, illustrating such panels in their final, joined configuration;

FIG. 7 is a perspective view of a panel comprising a portion of the claimed invention, provided with a mortise extending entirely through the width of the panel;

FIG. 8 is a view similar to the view shown in FIG. 7 in which the mortise thereof is merely recessed in a planar surface of the panel;

FIG. 9 is a perspective view of a panel comprising a component of the present invention provided with singular tenons on opposite edges thereof

FIG. 10 is a view similar to the view shown in FIG. 9, illustrating a panel provided with pairs of tenons on opposite edges thereof; and

FIGS. 11 through 22 illustrate sequential views of securing a number of panels as shown in FIGS. 1 through 10 to form a structure as shown in FIG. 22.

### DETAILED DESCRIPTION OF THE PREFERRED EMBODIMENTS OF THE INVENTION

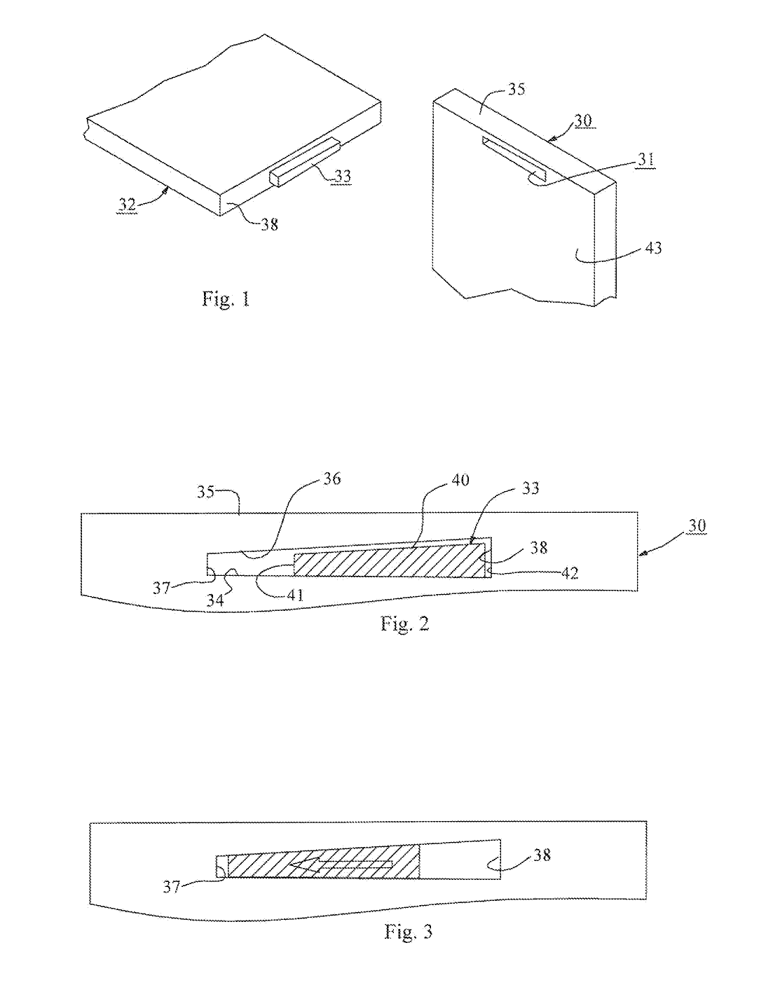

Referring to FIGS. 1 through 3, there is illustrated a preferred embodiment of the invention which includes a first panel 30 provided with a mortise 31 and a second panel 32 provided with a tenon 33. As best shown in FIG. 2, mortise 31 includes a bottom surface 34 disposed adjacent and parallel to upper edge 35, an upper surface 36 which diverges along the length thereof relative to bottom surface 34 and a pair of longitudinally spaced end surfaces 37 and 38 Bottom and upper surfaces 34 and 36 may be formed smoothly or irregularly in texture. Tenon 33 is formed as a projection from edge surface 38 of panel 32 and includes a bottom surface 39 adapted to seat on surface 34 of mortise 31 when the tenon is inserted into the mortise as shown in FIG. 2, an upper surface 40 which diverges along the length of the tenon relative to bottom surface 39 and is spaced relative to upper surface 36 of the mortise when inserted into the larger end of the mortise as shown in FIG. 2 and a pair of end surfaces 41 and 42 which are spaced longitudinally a distance less than the longitudinal spacing of end surfaces 37 and 38 of the mortise. Upon insertion of tenon 33 of panel 32 into mortise 31 of panel 30 as shown in FIG. 2 with edge 38 of panel 32 engaging planar surface 43 of panel 30 and displacing panel 32 relative to panel 30 along a line of travel parallel to surface 39 of mortise 31, tenon 33 will be displaced from the position shown in FIG. 2 to the position shown in FIG. 3 to firmly secure panel 32 to panel 30. The texture of the engaging surfaces of tenon 33 and mortise 31 may be sufficient to wedgingly fit the tenon in the mortise as shown in FIG. 3 and/or an adhesive or other bonding agent may be applied to the engaging surfaces of the tenon and mortise to firmly secure the panels together.

The length of the tenon purposefully is formed of a smaller length than the length of the mortise to permit the insertion of the tenon into the wider portion of the mortise as shown in FIG. 2 prior to displacing the tenon in the mortise from the position shown in FIG. 2 to the final position shown in FIG. 3. The disposition of mortise 31 in panel 30 can be anywhere in surface 43 depending upon the desired orientation of panel 32 relative to panel 30. The size and positioning of tenon 33 along adjoining edge 38 and length and positioning of mortise 33 along a length of panel 30 also would be dependent upon the desired orientation of such panels.

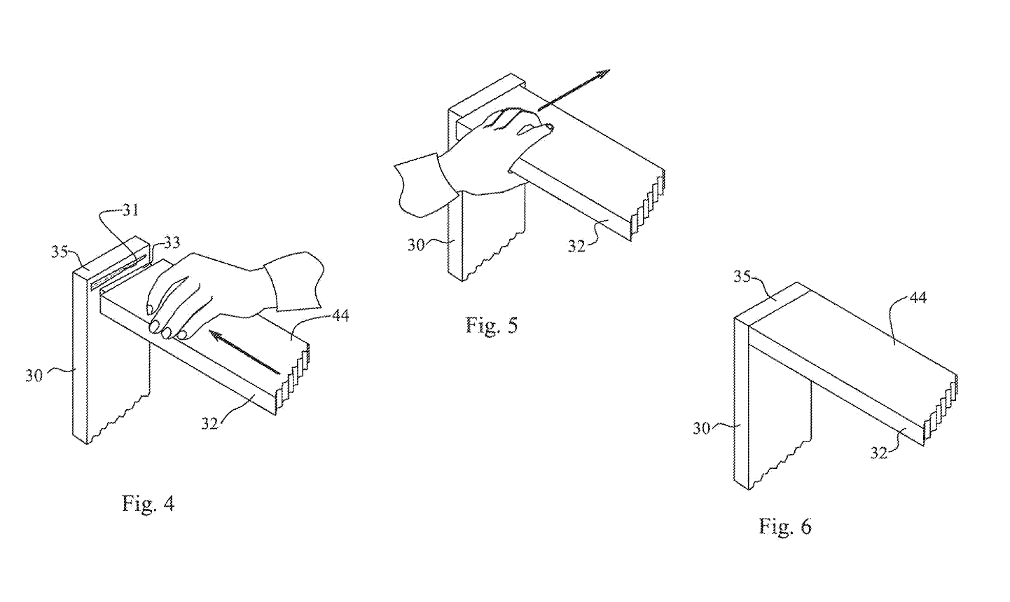

FIGS. 4 and 5 illustrate the manner in which panels 30 and 33 are assembled together to provide a right angle configuration of such panels as shown in FIG. 6. Initially, panel 32 is positioned as shown in FIG. 4 with the wider end of tenon 33 aligned with the wider end of mortise 31 and displaced in the direction as shown by the arrow so that the tenon is inserted into the mortise with the wider end of the mortise being received within the wider portion of the mortise. With the tenon thus inserted in the mortise, panel 32 is displaced in the direction as shown by the arrow in FIG. 5 to the final position as shown in FIG. 6. The disposition of mortise 31 relative to edge surface 35 of panel 30 and the disposition of tenon 33 relative to planar surface 33 of panel 32 may be arranged so that when such panels are joined together as shown in FIGS. 4 and 5 to produce the panel arrangement as shown in FIG. 6, end surface 35 of panel 30 and planar surface 44 of panel 32 will lie in the same plane.

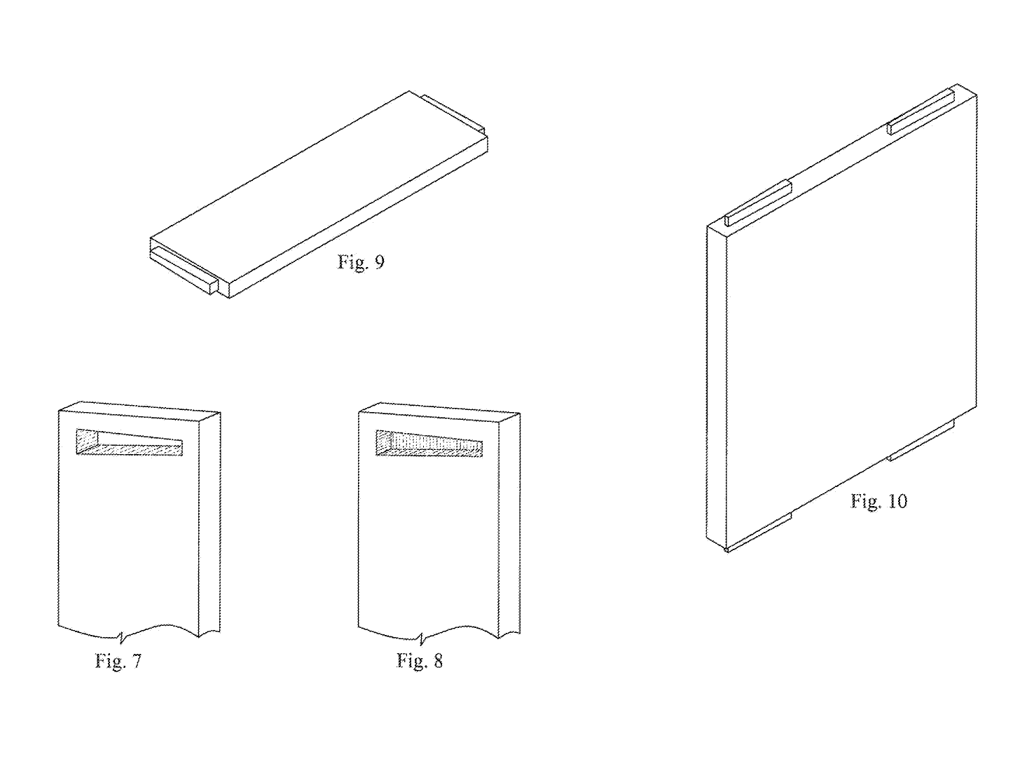

A mortise in a panel to be joined to another panel may extend entirely through such panel as shown in FIG. 7 or simply may be recessed a portion of the thickness of the panel as shown in FIG. 8. In addition, a panel may be formed with multiple tenons for being joined to a multitude of other panels as shown in FIG. 9 and also may be provided with multiple tenons on a single edge as shown in FIG. 10

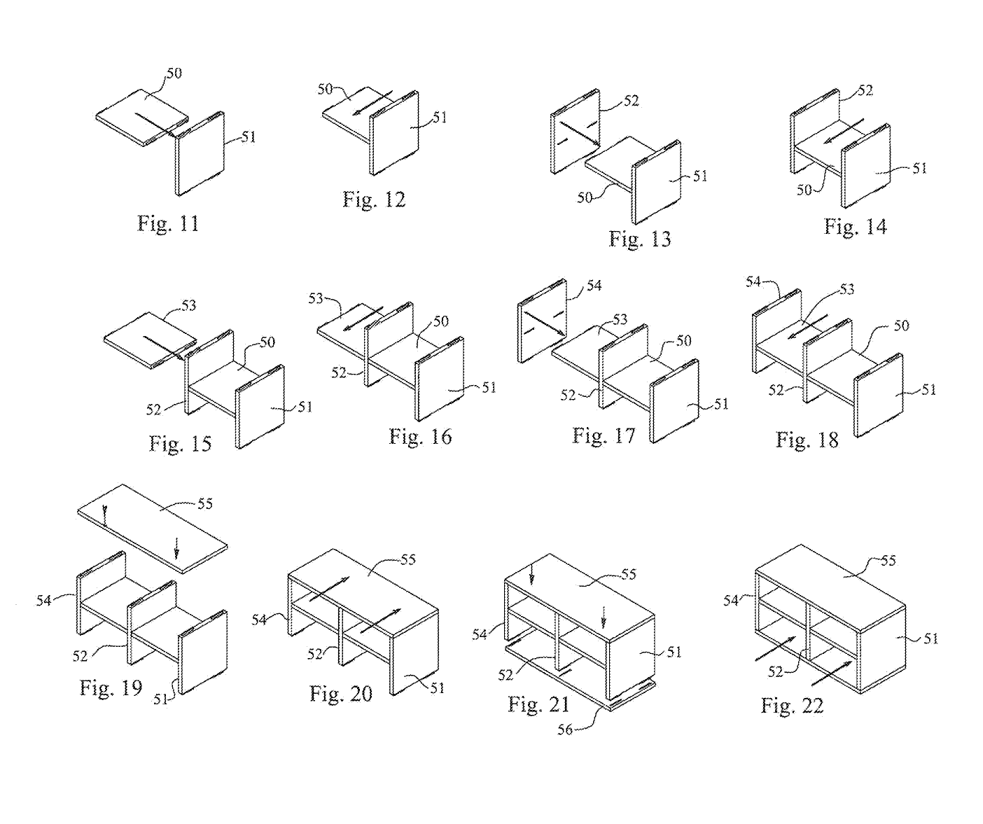

As shown in FIGS. 11 through 22, the method shown in FIGS. 1 through 6 for securing panels together may be utilized to form a structure as shown in FIG. 22. Sequentially, such structure may he formed by inserting the tenons of a horizontal panel 50 into the mortises of panel 51 and then displacing panel 50 relative to panel 51 as shown in FIGS. 11 and 12, displacing a panel 52 relative to mounted panel 50 to receive the tenons of panel 50 into the mortises of panel 52 and then displacing panel 50 to join panel 52 relative thereto as shown in FIGS. 13 and 14, displacing panel 53 relative to panel 52 to insert the tenons of panel 53 in mortises of panel 52 and displacing panel 53 relative to mounted panel 52 as shown in FIGS. 15 and 16, displacing panel 54 relative to mounted panel 53 to receive the tenons of panel 53 into the mortises of panel 54 and displacing panel 54 relative to panel 53 as shown in FIGS. 17 and 18, displacing upper panel 55 relative to mounted panels 51, 52 and 54 to receive the tenons on the upper edges of mounted panels 51, 52 and 54 in mortises formed on the underside of upper panel 55 and displacing panel 55 relative to mounted panels 51, 52 and 54 as shown in FIGS. 19 and 20 and displacing the unit shown in FIG. 20 relative to a bottom panel 56 to insert tenons provided on the lower edges of mounted panels 51, 52 and 54 in mortises provided on upper surface of bottom panel 56 and displacing such unit relative to bottom panel 56 as shown in FIGS. 21 and 22 to provide the assembled unit as shown in FIG. 22. The unit as shown in FIG. 22 may be finished as desired or further assembled by forming and inserting drawers in the compartments provided, further mounting certain hardware such as slides, pull handles and/or knobs.

The method as described for forming a unit as shown in FIG. 22 has several advantages over existing practices in forming such units. The tapered mortise and tenon joints can be easily machined using modern CNC machine tools common in wood production facilities utilizing simple, standard, low cost straight tooling. The simplicity of the joint design is more efficient to produce than complex joints that require special tooling and more extensive machining. The amount of force required to slide a joint and the resulting force holding the parts together can be adjusted by adjusting the geometry of the joint taper and clearance. Properly configured, the joint can be assembled using just hand pressure, resulting in sufficient retaining force, even before any glue or any other bonding agent has fully dried or cured. Such simple assembly process makes it practical to ship unassembled components of a unit to an installation site and perform final assembly just before installation, eliminating the cost of shipping a bulkier assembled product to the installation site, eliminating additional effort of unloading bulky items and saving space for storing such items at the installation site prior to assembly of the unit. A further advantage is that no additional hardware, fixtures or fasteners are required, eliminating the need to purchase, inventory and install such items.

From the foregoing detailed description, it will be evident that there are a number of changes, adaptations and modifications of the present invention, which come within the province of those persons having ordinary skill in the art to which the aforementioned invention pertains. However it is intended that all such variations not departing from the spirit of the invention be considered as within the scope thereof as limited solely by the appended claims.

I claim:

1. A method of adjoining first and second workpieces, together comprising:
forming a mortise in said first workpiece and a tenon in said second workpiece wherein one of said mortise and tenon is provided with diverging surfaces along a length thereof;
inserting the tenon of said second workpiece into the mortise of said first workpiece to position said workpieces together; and
displacing one of said workpieces relative to the other of said workpieces along a line of travel substantially parallel to a length of said mortise to cause said diverging surfaces of said one of said mortise and tenon to engage surfaces of the other of said mortise and tenon thereby positioning said workpieces in a final relationship.

2. The method according to claim 1 wherein said engaging surfaces are roughened.

3. The method of claim 1 including wedgingly fitting said engaging surfaces together.

4. The method of claim 1 including adhesively securing said engaging surface together.

5. The method of claim 1 including forming said mortise with a greater longitudinal length than the longitudinal length of said tenon.

6. The method of claim 1 including forming a pair of opposed, diverging surfaces along a a length of said mortise of said first workpiece and forming a pair of diverging surfaces along a length of said tenon of said second workpiece, and displacing said second workpiece along the length of said mortise upon insertion of said tenon in said mortise, to cause said surfaces of said tenon and mortise to engage.

7. The method of claim 6 wherein said surfaces are roughened.

8. The method of claim 6 including wedgingly fitting said engaging surfaces together.

9. The method of claim 6 including adhesively securing said engaging surfaces together.

10. The method of claim 6 including forming said mortise with a length greater than the length of said tenon.

11. An assembly comprising:
a first workpiece provided with a mortise and
a second workpiece provided with a tenon inserted in said mortise;
wherein one of said mortise and said tenon is provided with a pair of diverging surfaces engaging a pair of opposed diverging; surfaces of the other of said mortise and said tenon, securing said workpieces together.

12. The assembly according to claim 11 wherein said diverging, engaging surfaces are roughened.

13. The assembly according to claim 11 wherein said engaging surfaces are wedgingly fitted together.

14. The assembly according to claim 11 wherein said engaging surfaces are adhesively secured together.

15. The assembly according to claim 11 wherein said mortise is recessed in a surface of said first workpiece.

16. The assembly according to claim 11 wherein said mortise extends through said first workpiece.

17. A structure comprising:
a plurality of constituent members secured together to provide a unit wherein in at least one adjoining set of said members, one of said adjoining members is provided with a mortise, the other of said adjoining members is provided with a tenon inserted into said one adjoining member and at least one of said mortise and said tenon is provided with a pair of diverging surfaces engaging a pair of opposed surfaces of the other of said mortise and said tenon, securing said member together.

18. The structure of claim 17 wherein said engaging surfaces are roughened.

19. The structure of claim 17 wherein said engaging surfaces are wedgingly fitted together.

20. The structure of claim 17 wherein said engaging surfaces are adhesively secured together.

21. The structure of claim 17 wherein the length of said mortise is greater than the length of said tenon to facilitate the insertion and displacement of said tenon relative to said mortise in adjoining said members.

22. The structure of claim 17 wherein said mortise is recessed in a surface of said one adjoining member.

23. The structure of claim 17 wherein said mortise extends through a wall of said one adjoining member.

24. The structure of claim 17 wherein said members comprise panels.

25. The structure of claim 24 wherein said mortise is disposed in a planar surface of one said panels and said tenon is disposed on an edge of the other of said panels.

26. The structure of claim 17 wherein both said mortise and said tenons are provided with diverging, engaging surfaces.

27. The structure of claim 26 wherein said engaging surfaces of said mortise and said tenon have at least one of roughened, wedge fit and adhesive set of surfaces.

28. The structure of claim 17 wherein said unit comprises one of a commercial piece of furniture and a household piece of furniture.

29. The structure according to claim 27 wherein said unit is provided with hardware including at least one of a nob, a pull and a slide.
